(19) United States
(12) Patent Application Publication
(10) Pub. No.: US 2017/0029566 A1
(43) Pub. Date: Feb. 2, 2017

(54) Method of Producing a Polyamide

(71) Applicant: BASF SE, Ludwigshafen (DE)

(72) Inventors: William E. Grant, Angelton, TX (US); Glenn B. Swanner, Brazoria, TX (US); Eric S. Noon, Flat Rock, MI (US); Cesar G. Ortiz, Prairievillie, LA (US); Joseph T. Flack, Clute, TX (US); Rolf Egbert Gruetzner, Obrigheim (DE)

(73) Assignee: BASF SE, Ludwigshafen (DE)

(21) Appl. No.: 15/303,993

(22) PCT Filed: Apr. 9, 2015
(86) PCT No.: PCT/US2015/025139

§ 371 Date: Oct. 13, 2016

Related U.S. Application Data
(60) Provisional application No. 61/979,753, filed on Apr. 15, 2014.

(51) Int. Cl. C08G 69/04; C08G 69/16

(52) U.S. Cl. CPC C08G 69/04; C08G 69/16

(57) ABSTRACT

A method produces a polyamide having an extractable fraction of oligomer of from 2 to 10 percent. The method includes introducing a monomer into a reactor and polymerizing the monomer to form a first intermediate having an extractable fraction of oligomer of greater than 10 percent, wherein the oligomer is a compound of 2 to 20 units of the monomer. The method includes transferring the first intermediate from the reactor into an extractor and introducing water into the extractor to form a second intermediate having an extractable fraction of oligomer that is less than the extractable fraction of the first intermediate, wherein the water is introduced at a temperature of less than 100° C. and wherein the water includes 0.1 to 3.0 weight percent of a plasticizer. Moreover, the method includes transferring the second intermediate into a dryer and applying air at a temperature of less than 125° C.

### FIELD OF THE DISCLOSURE

The present disclosure generally relates to a method of producing a polyamide having a particular extractable fraction of oligomer. More specifically, the method utilizes water and air at particular temperatures to produce the polyamide.

### DESCRIPTION OF THE RELATED ART

Polyamides are well known in the art and are used in products such as engineering plastics in automobiles, electrical housings, electronic appliances, and building materials. However, many polyamides are formed in such a way that all, or almost all, of extractable oligomers are removed during manufacturing. Although low extractable polyamides are suitable for some applications, many other applications require varying amounts of extractable oligomers to be present in the polyamide because these oligomers provide desired physical properties. Accordingly, many low extractable polyamides must be doped with oligomers to achieve acceptable physical properties. As just one example, polyamides may be doped with caprolactam to adjust physical properties such as gloss and texture and to lower glass transition temperatures. Further, caprolactam may be used to soften polyamides and ease their flow through extruders. Although useful, doping is a time-consuming and expensive manufacturing step and adds to the cost and complexity of forming and using the polyamides. In addition, doping can lead to problems such as agglomeration of caprolactam, especially during transport of the polyamide. This potential agglomeration increases handling and production costs. Accordingly, there remains an opportunity to develop an improved method for forming polyamides.

### BRIEF DESCRIPTION OF THE DRAWING

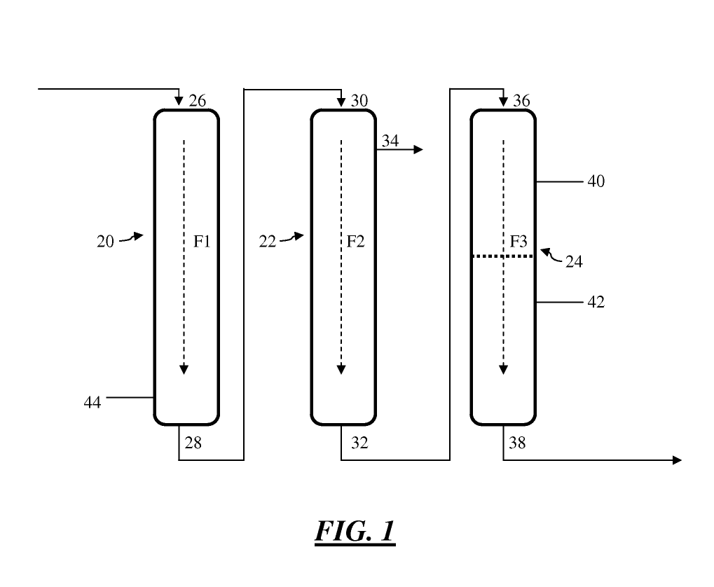

Other advantages of the present disclosure will be readily appreciated, as the same becomes better understood by reference to the following detailed description when considered in connection with the accompanying drawing wherein FIG. 1 is a process schematic illustrating one embodiment of the method of this disclosure.

### SUMMARY OF THE DISCLOSURE

The instant disclosure provides a method for producing a polyamide having an extractable fraction of oligomer of from 2 to 10 percent as determined by ISO 6427. The method includes the steps of introducing a monomer into a reactor and polymerizing the monomer in the reactor to form a first intermediate having an extractable fraction of oligomer of greater than 10 percent as determined by ISO 6427. The oligomer is a compound of 2 to 20 units of the monomer. The method also includes the step of transferring the first intermediate from the reactor into an extractor. Furthermore, the method includes the step of introducing water into the extractor to form a second intermediate having an extractable fraction of oligomer that is less than the extractable fraction of oligomer of the first intermediate, as determined by ISO 6427. The water is introduced at a temperature of less than 100° C. and includes 0.1 to 3.0 weight percent of a plasticizer upon introduction into the extractor. Moreover, the method includes the steps of transferring the second intermediate from the extractor into a dryer and applying air to the second intermediate in the dryer wherein the air is at a temperature of less than 125° C. to form the polyamide having the extractable fraction of oligomer of from 2 to 10 percent as determined by ISO 6427.

### DETAILED DESCRIPTION OF THE DISCLOSURE

The instant disclosure provides a method of producing a polyamide. The polyamide typically includes, is, consists essentially of, or consists of, a dimer, trimer, tetramer, or polymer formed from polymerization of one or more monomers. The polyamide of this disclosure may be any known in the art. However, the polyamide is typically further defined as a polymer that is linked together through peptide bonds and that is formed from a polymerization reaction of amide monomers. The polyamide may be, include, consist essentially of, or consist of, a homopolymer (e.g. nylon 6), a co-polymer (e.g. nylon 6,6), a terpolymer (e.g. nylon 6/66), or any other higher polymer that is formed from more than three or more different monomers. In one embodiment, the polyamide is formed from a condensation reaction of a first monomer having an amino group and a second monomer having a carboxyl group or acid chloride group. Alternatively, the polyamide may be formed from a condensation reaction of two molecules of the first monomer wherein the first monomer has both an amino group and a carboxyl group or acid chloride group. In still another embodiment, the first monomer and the second monomer are both bi-functional wherein one of the two monomers has two amino groups and the other of the two monomers has two carboxyl groups, two acid chloride groups, or one carboxyl group and one acid chloride group.

Typically, the polyamide may be or include, consist essentially of, or consist of one or more nylons, aramids, proteins, metal poly(aspartates) such as sodium poly(aspartate), and combinations thereof. Nylons are condensation copolymers typically formed by reacting diamines and dicarboxylic acids to form peptide bonds. In one embodiment, the nylon is further defined as having less than 85% of amide-linkages attached directly (—CO—NH—) to two aliphatic groups. Aramids, also known as aromatic polyamides, are typically formed by reacting amines and carboxylic acid halides. In one embodiment, the aramid is further defined as having at least 85% of amide linkages (—CO—NH—) attached directly to two aromatic rings. The aramid may be any known in the art but is typically further defined as an AABB polymer, such as Nomex®, Kevlar®, Twaron® and/or New Star. As is well known in the art, Nomex® and New Star include predominantly meta-linkages and are typically further defined as poly-metaphenylene isophthalamides. Kevlar® and Twaron® are both para-phenylene terephthalamides (PPTA), the simplest form of an AABB para-polyaramide. PPTA is a product of p-phenylene diamine (PPD) and terephthaloyl dichloride (TDC or TCl). Alternatively, the aramid may be further defined as the reaction product of PPD, 3,4′-diaminodiphenylether, and terephthaloyl chloride (TCl). Proteins are organic compounds including amino acids arranged in a linear chain and joined together by peptide bonds between carboxyl and amino groups. Metal poly(aspartates), such as sodium poly(aspartate), are known in the art as condensation polymers based on aspartic acid.

More typically, the polyamide may be or include, consist essentially of, or consist of one or more of polyamide 6, polyamide 6,6, polyamide 6/66, poly(4-aminobutyric acid) (nylon 4), poly(7-aminoheptanoic acid) (nylon 7), poly(8-aminooctanoic acid)(nylon 8), poly(9-aminononanoic acid) (nylon 9), poly(10-aminodecanoic acid) (nylon 10), poly(11-aminoundecanoic acid) (nylon 11), poly(12-aminododecanoic acid) (nylon 12), nylon 4,6, poly(hexamethylene sebacamide) (nylon 6,10), poly(heptamethylene pimelamide) (nylon 7,7), poly(octamethylene suberamide) (nylon 8,8), poly(hexamethylene azelamide) (nylon 6,9), poly(nonamethylene azelamide) (nylon 9,9), poly(decamethylene azelamide) (nylon 10,9), poly(tetramethylenediamine-co-oxalic acid) (nylon 4,2), the polyamide of n-dodecanedioic acid and hexamethylenediamine (nylon 6,12), the polyamide of dodecamethylenediamine and n-dodecanedioic acid (nylon 12,12), trimethylene adipamide/hexamethylene azelaiamide copolymer (nylon trimethyl 6,2/6,2), hexamethylene adipamide-hexamethylene-azelaiamide caprolactam copolymer (nylon 6,6/6,9/6), poly(tetramethylenediamine-co-isophthalic acid) (nylon 4,I), polyhexamethylene isophthalamide (nylon 6,1), hexamethylene adipamide/hexamethylene-isophthalamide (nylon 6,6/61), hexamethylene adipamide/hexamethyleneterephthalamide (nylon 6,6/6T), poly (2,2,2-trimethylhexamethylene terephthalamide), poly(m-xylylene adipamide) (MXD6), poly(p-xylylene adipamide), poly(hexamethylene terephthalamide), poly(dodecamethylene terephthalamide), polyamide 6T/6I, polyamide 6MXDT/I, polyamide MXDI, a terpolymer of lauryl lactam, isophthalic acid and bis(4-amino-3-methylcyclohexyl)methane and polynorbornamide, and combinations thereof. Even more typically, the polyamide is chosen from polyamide 6, polyamide 6,6, polyamide 6/66, and combinations thereof. Most typically, the polyamide is further defined as polyamide 6. Polyamide 6 is also known as polycaprolactam and is commercially available from BASF Corporation under the trade name Ultramid® B. Polyamide 6,6 is a copolymer of hexamethylene diamine and adipic acid and is commercially available from BASF Corporation under the trade name Ultramid® A. Polyamide 6/66 is a co-polymer of polyamide 6 and polyamide 66 and is commercially available from BASF Corporation under the trade name of Ultramid® C. As used in the multiple paragraphs above, the terminology “consists essentially of” typically describes that the polyamide is free of other polymers (not described above) that, if present, would affect the physical properties of the polyamide (such as extractable fraction), wherein this effect and such properties would be recognized by those of skill in the art.

The polyamide has an extractable fraction of oligomer of from 2 to 10 percent as determined by the International Organization for Standardization (ISO) testing method 6427. In additional embodiments, the polyamide has an extractable fraction of 2.5 to 9.5, from 3.0 to 9.0, from 3.5 to 8.5, from 4.0 to 8.0, from 4.5 to 7.5, from 5.0 to 7.0, from 5.5 to 6.5, from 6.0 to 6.5, from 2 to 8, from 4 to 6, from 3 to 5, about 2.1, 2.2, 2.3, 2.4, 2.5, 2.6, 2.7, 2.8 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0,±0.1, 0.05, or 0.01, as determined by ISO 6427. As is well known in the art, ISO 6427 includes a determination of extractable fraction of oligomer at 25° C. in methanol. In additional non-limiting embodiments, all values and ranges of values, both whole and fractional, within one or more of the aforementioned ranges, are hereby expressly contemplated. Moreover, the terminology “about” typically describes that the value may fluctuate by, for example, ±1, 2, 3, 4, or 5, %.

As understood by those skilled in the art, the extracted oligomer may be or include, but are not limited to, cyclic dimers, cyclic trimers, cyclic tetramers, and cyclic pentamers through octamers, of various polyamides, such as nylon 6. In various embodiments, these oligomers are high molecular weight derivatives of caprolactam. Typically, the oligomer is a compound of 2 to 20, 3 to 19, 4 to 18, 5 to 17, 6 to 16, 7 to 15, 8 to 14, 9 to 13, 10 to 12, or 11, units of the monomer (bonded together). For example, the oligomer may be or be formed from 2 to 20 (or any range therebetween) molecules of caprolactam polymerized together. In additional non-limiting embodiments, all values and ranges of values within one or more of the aforementioned ranges, are hereby expressly contemplated.

The polyamide may have a relative viscosity (RV) of from 2.0 to 3.0, of from 2.1 to 2.8, of from 2.2 to 2.7, or of from 2.3 to 2.6, as determined by ISO 307 calculated by the Huggins method. According to ISO 307, relative viscosity is determined at 25° C. by 1% [m/v] of the first polyamide resin in 96% [m/m] sulfuric acid. The polyamide may also have a viscosity number (VN) of from 100 to 170, of from 100 to 160, of from 110 to 150, or of from 116 to 140, ml/g as determined by ISO 307. According to ISO 307, viscosity number is determined at 25° C. by 0.5% [m/v] of the first polyamide resin in 96% [m/m] sulfuric acid. Further, the polyamide may have a maximum moisture content of 0.5, 0.35, or 0.27% [m/m], as determined by ISO 15512. The polyamide may include water, i.e., moisture. For example, the polyamide may include less than 1%, less than 0.75%, from 0.2 to 0.5%, or from 0.05 to 0.5%, by weight of moisture. However, it is contemplated that the polyamide may include any amount of moisture, as selected by one of skill in the art. Additionally, the polyamide may have a melting point of 220° C. and/or a density of 1.12 to 1.13 g/cm³. In additional non-limiting embodiments, all values and ranges of values, both whole and fractional, within one or more of the aforementioned ranges, are hereby expressly contemplated.

The polyamide may also include a lubricant. The lubricant may be any known in the art including, but not limited to, polyalkylene waxes, aliphatic amides, salts of fatty acids, silicones, and mixtures thereof. Most typically, the lubricant is chosen from salts of fatty acids, silicones, and mixtures thereof. In one embodiment, the lubricant includes a fatty acid. In another embodiment, the lubricant includes a combination of a N,N′-ethylenebis(stearamide) wax and a silicone oil. The N,N′-ethylenebis(stearamide) wax is commercially available from Lonza, Inc. under the trade name of ACRAWAX® C-V. The silicone oil is commercially available from Dow Corning Corporation of Midland, Mich., under the trade name Dow Corning® Fluid. In various embodiments, EBS, EBO, erucamide, Si oil, and combinations thereof can be utilized. The lubricant may be present in an amount of from 10 to 5000, from 100 to 5000, from 200 to 5000, from 200 to 2500, from 200 to 2000, from 200 to 1500, from 200 to 1200, from 200 to 1000, from 200 to 800, from 200 to 600, from 200 to 400, from 400 to 1200, from 400 to 1000, from 400 to 800, or from 400 to 600, parts by weight per one million parts by weight of the polyamide. In one embodiment, the lubricant includes the combination of the N,N′-ethylenebis(stearamide) wax (e.g. in an amount of 1200 ppm) and the silicone oil (e.g. in an amount of 400 ppm).

### Method of Forming the Polyamide:

Referring back to the method, the method includes the steps of (A) introducing a monomer into a reactor and (B) polymerizing the monomer in the reactor to form the polyamide.

(A) Introducing the Monomer into the Reactor:

The monomer may be any compound or molecule known in the art capable of undergoing polymerization to form the polyamide. Thus, the monomer may include or be the polymerization product of a single compound or two or more different compounds, so long as the polymerization product itself is capable of undergoing further polymerization to form the polyamide of this disclosure.

In various embodiments, the monomer is chosen from caprolactam, 4-aminobutyric acid, 7-aminoheptanoic acid, 8-aminooctanoic acid, 9-aminononanoic acid, 10-aminodecanoic acid, 11-aminoundecanoic acid, 12-aminododecanoic acid, hexamethylene sebacamide, heptamethylene pimelamide, octamethylene suberamide, hexamethylene azelamide, nonamethylene azelamide, decamethylene azelamide, tetramethylenediamine-co-oxalic acid, n-dodecanedioic acid, hexamethylenediamine, dodecamethylenediamine, trimethylene adipamide, tetramethylenediamine-co-isophthalic acid, hexamethylene isophthalamide, hexamethyleneterephthalamide, 2,2,2-trimethylhexamethylene terephthalamide, m-xylylene adipamide, p-xylylene adipamide, hexamethylene terephthalamide, dodecamethylene terephthalamide, isomers thereof, and combinations thereof. In another embodiment, the monomer is chosen from hexamethylene diamine, adipic acid, caprolactam, and combinations thereof. Typically, the monomer is further defined as caprolactam, i.e., a caprolactam monomer.

The monomer may be introduced into the reactor in a continuous or batch mode. The monomer may be introduced into any portion of the reactor, typically the top of the reactor, for example, through a line (26) as set forth in FIG. 1. Typically, the monomer is introduced into the reactor in a continuous mode. In addition, the monomer may be introduced into the reactor as a solid, a liquid, a gas, a gel, a gum, a paste, a dispersion, or as a powder. Typically, the monomer is introduced into the reactor as a liquid. In one embodiment, the monomer is introduced into a top of the reactor such that the monomer can move downwards in the reactor and polymerize to form the polyamide of this disclosure. In another embodiment, the monomer is introduced into a side of the reactor also so that the monomer can move downwards and polymerize.

The monomer may be combined with a carrier and be utilized as a masterbatch. In one embodiment, the terminology “masterbatch” is further defined as a concentrate of the monomer in the carrier. In another embodiment, the terminology “masterbatch” is further defined as a homogeneous mixture of the monomer in the carrier. In still another embodiment, the terminology “masterbatch” is further defined as a mixture including an increased concentration of the monomer in the carrier, wherein the mixture is later diluted with another compound. Typically, an optional step of forming the masterbatch is defined as combining the monomer and the carrier in a desired weight ratio. The step of combining may be further defined as mixing, extruding, or any other type of mixing step known in the art.

The masterbatch may include any ratio of the monomer to the carrier, such that the monomer and the carrier may be present in the masterbatch in any amount as desired by one of skill in the art. In one embodiment, the monomer is present in an amount of up to about 50 parts by weight per 100 parts by weight of the masterbatch. In other embodiments, the monomer is present in amounts of from 1 to 50, from 25 to 50, from 1 to 25, from 1 to 20, from 1 to 15, from 1 to 10, or from 1 to 5, parts by weight per 100 parts by weight of the masterbatch. In still other embodiments, the monomer is present in amounts of about 1, 2, 3, or 4 parts by weight per 100 parts by weight of the masterbatch. The masterbatch may include the monomer and the carrier, consist essentially of the monomer and the carrier, or consist of the monomer and the carrier. The terminology “consist essentially of” refers to the masterbatch including the monomer and the carrier but not any other compounds that would materially affect the basic and novel characteristics of the masterbatch, such as additional polymers. Moreover, the terminology “about” typically describes that the value may fluctuate by, for example, ±1, 2, 3, 4, or 5, %.

The carrier may be any compound or mixture of compounds known in the art and is typically chemically and/or physically compatible with the monomer and the polyamide. Typically, the masterbatch, including the monomer and the carrier, has a similar melt viscosity as the polyamide formed in this disclosure for equivalent relative solution viscosities. This similarity allows the masterbatch to melt with the polyamide being formed which leads to maximized homogenous formation of the polyamide, tends to maximize an extent of polymerization (i.e., amounts and rates of polymerization) that can occur in the polyamide reactors, tends to maximize rates of polyamide discharge from the reactors, and tends to reduce excessive foaming in the reactors thereby avoiding problems associated with poor agitation and non-uniformity of the polyamide. Use of the masterbatch also tends to reduce issues associated with the hydroscopicity and agglomeration, issues associated with inconsistent and non-homogenous polymerization, and issues associated with clogging of supply pipes. Said differently, use of the masterbatch eases handling and processing issues associated with polymerization.

The carrier is typically chosen from polyesters, modified polyolefins, polyamides, and combinations thereof. In one embodiment, the carrier is the same as the polyamide formed from the instant method. For example, the carrier may be a polyamide different from the polyamide formed from the instant method. The carrier may include a mixture of polyamides. In one embodiment, the carrier is further defined as a thermoplastic carrier. In another embodiment, the carrier is a plastic. In still another embodiment, the carrier is chosen from nylon 6, nylon 6/6, polyesters, olefins, and combinations thereof. In various other embodiments, the carrier includes one or more of a terpolymer of ethylene or mixtures of ethylene with higher alpha-olefins, an acrylic, methacrylic acid or glycidyl ester, maleic anhydride, and combinations thereof. In one embodiment, the carrier is further defined as a semi-crystalline thermoplastic polyester including, but not limited to, poly(butylene terephthalate), poly(trimethylene terephthalate), poly(ethylene terephthalate-co-isophthalate), and combinations thereof. Typically, the carrier is not a liquid.

In various embodiments, the masterbatch has relative solution viscosity of from 2 to 4.5, of from 2.2 to 3, or of from 2.2 to 2.3. Without intending to be bound by any particular theory, it is believed that many benefits of this disclosure are associated with similarities in the melt viscosity of the polyamide and the melt viscosity of the masterbatch based upon equivalent relative solution viscosities for both the polyamide and the masterbatch.

If a masterbatch is utilized, the method may also or alternatively include the step of introducing the masterbatch into a reactor. In other words, the step of introducing the monomer may be replaced with the step of introducing the masterbatch, if the masterbatch includes the monomer. The masterbatch may be introduced into the reactor by any mechanism known in the art including in a continuous mode or in a batch mode. In one embodiment, the masterbatch is introduced into the reactor in a continuous mode. The masterbatch may be introduced into the reactor as a solid, a gas, a gel, a gum, a paste, a dispersion, or as a powder. In other embodiments, the masterbatch is introduced into the reactor as a solid or paste and most typically as a solid. It is contemplated that the paste may include water or may be free from water. The paste may be oligomeric.

Alternatively, the masterbatch and the monomer may be introduced into the reactor simultaneously or sequentially. The masterbatch may be combined with the monomer before introduction into the reactor. Alternatively, the masterbatch and the monomer may be introduced into the reactor separately. Like the masterbatch, the monomer may be introduced into the reactor in a continuous or batch mode. Typically, the monomer is introduced into the reactor in a continuous mode. In addition, the monomer may be introduced into the reactor as a solid, a liquid, a gas, a gel, a gum, a paste, a dispersion, or as a powder. Typically, the monomer is introduced into the reactor as a liquid. In one embodiment, the monomer is introduced into a top of the reactor such that the monomer can move downwards in the reactor and polymerize to form the polyamide of this disclosure. For example, the monomer may flow (F1) downwards, as set forth in FIG. 1. In another embodiment, the monomer is introduced into a side of the reactor also so that the monomer can move downwards and polymerize. Most typically, the masterbatch and the monomer are simultaneously introduced into a top of the reactor in a continuous mode from different sources. That is, the masterbatch and the monomer are not typically combined prior to introduction into the reactor. Alternatively, the masterbatch and the monomer may be premixed and introduced into the reactor simultaneously. In other embodiments, the masterbatch and the monomer are introduced into the reactor sequentially with either the masterbatch or the monomer introduced first.

The reactor that is utilized in this method is not particularly limited and may be any known in the art. For example, the reactor may as generally shown in FIG. 1 as the reactor (20). In one embodiment, the reactor is further defined as a VK (Vereinfacht Kontinuierlich) tube reactor (i.e., a simplified continuous tube reactor). Typically, VK tube reactors include a vertical tube operated at atmospheric pressure wherein heating and prepolymerization take place in an upper part and the polyamide is formed in a lower part. Alternatively, the reactor may be further defined as an AKU (Algemene Kunstzijde Unie) reactor. It is also contemplated that the reactor may be a batch reactor. Of course, the instant disclosure is not limited to any particular type of reactor.

### (B) Polymerizing the Monomer in the Reactor to Form a First Intermediate:

The step of polymerizing the monomer in the reactor is also not particularly limited and may include one or more steps known in the art. The step of polymerizing may include reacting caprolactam with water to form 6-aminohexanoic acid as is shown below:

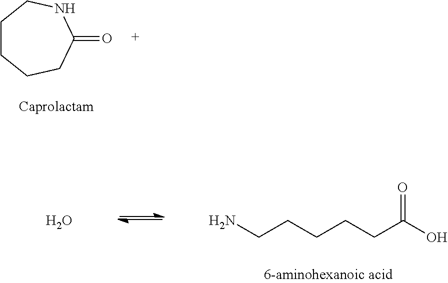 [SMILES: O=C1CCCCCN1 ; O ; NCCCCCC(=O)O]

As such, a polyamide resin may be formed from the following chemical reaction:

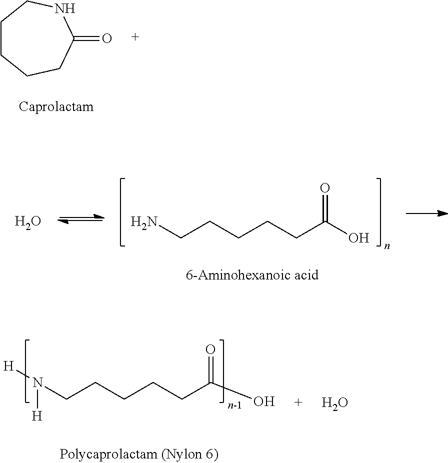

wherein n is an integer of two or greater.

The step of polymerizing typically forms a first intermediate, i.e., not a final product or the final polyamide, that has an extractable fraction of oligomer of greater than 10 percent as determined by ISO 6427. Alternatively, the first intermediate may have an extractable fraction of from 10 to 17, from 10 to 16, from 10 to 15, from 10 to 14, from 10 to 13, from 10 to 12, from 10 to 11, from 11 to 15, from 11 to 14, from 11 to 13, from 11 to 12, from 12 to 15, from 12 to 14, from 12 to 13, from 13 to 15, from 13 to 14, or from 14 to 15, as determined by ISO 6427. In additional non-limiting embodiments, all values and ranges of values, both whole and fractional, within one or more of the aforementioned ranges, are hereby expressly contemplated. Although the first intermediate is not the final amide produced by this method, the first intermediate may itself be, include, consist essentially of, or consist of, a polyamide. Although the first intermediate is not the final amide produced by this method, the first intermediate may itself be, include, consist essentially of, or consist of, a polyamide.

The step of polymerizing is typically further defined as heating the monomer to a temperature of from 230 to 300, from 235 to 295, from 240 to 290, from 245 to 285, from 250 to 280, from 255 to 275, from 260 to 270, or from 265 to 270, ° C., to cause the monomer to polymerize and form the first intermediate. The step of polymerizing typically occurs in a time of from 4 to 24, from 5 to 23, from 6 to 22, from 7 to 21, from 8 to 20, from 9 to 19, from 10 to 18, from 11 to 17, from 12 to 16, from 13 to 15, or from 14 to 15, hours. In one embodiment, the step of polymerizing is further defined as forming the first intermediate in the reactor in a time of at least 8 hours. In additional non-limiting embodiments, all values and ranges of values, both whole and fractional, within one or more of the aforementioned ranges, are hereby expressly contemplated.

(C) Transferring the First Intermediate from the Reactor into an Extractor:

The method also includes the step of (C) transferring the first intermediate from the reactor into an extractor, for example through exit line (28) and intro entrance line (30), as set forth in FIG. 1. This step occurs after the step of polymerizing the monomer in the reactor. The step of transferring the first intermediate may occur utilizing any method known in the art. Typically, the first intermediate is present and/or transferred as a slurry with water from the reactor into the extractor. However, it is contemplated that the first intermediate may include water or may be free of water.

The extractor itself is not particularly limited. For example, the extractor may be as generally shown in FIG. 1 as extractor (22). In one embodiment, the first intermediate flows downwards (F2) in the extractor, as set forth in FIG. 1.

The step of transferring may occur at any temperature, rate, pressure, etc. In various embodiments, the first intermediate is transferred at a temperature of from 80 to 100, 81 to 99, 82 to 98, 83 to 97, 84 to 96, 85 to 95, 86 to 94, 87 to 93, 88 to 92, 89 to 91, or 90 to 91, ° C. In additional non-limiting embodiments, all values and ranges of values, both whole and fractional, within one or more of the aforementioned ranges, are hereby expressly contemplated.

(D) Introducing Water into the Extractor to Form a Second Intermediate:

The method also includes the step of (D) introducing water into the extractor (and combining the water and the first intermediate) to form a second intermediate, i.e., not a final product or the final polyamide and different from the first intermediate. The second intermediate has an extractable fraction of oligomer that is less than the extractable fraction of the first intermediate described above, as determined by ISO 6427. In various embodiments, the extractable fraction of the second intermediate is 7 to 11, 8 to 10, or 9 to 10, as determined by ISO 6427. In additional non-limiting embodiments, all values and ranges of values, both whole and fractional, within one or more of the aforementioned ranges, are hereby expressly contemplated. Although the second intermediate is not the final amide produced by this method, the second intermediate may itself be, include, consist essentially of, or consist of, a polyamide.

The water may be introduced into the extractor at any temperature and/or rate. The water is typically introduced at a temperature of less than 100, 95, 90, 85, 80, 75, 70, 65, 60, 55, 50, 45, 40, 35, 30, or 25, ° C. In various embodiments, the water is introduced at a temperature of from 25° C. to 70° C., from 30° C. to 65° C., from 35° C. to 60° C., from 40° C. to 55° C., or from 45° C. to 50° C. In additional non-limiting embodiments, all values and ranges of values, both whole and fractional, within one or more of the aforementioned ranges, are hereby expressly contemplated. The water may be introduced into the extractor, for example, through line (44), as set forth in FIG. 1.

The water introduced into the reactor typically includes 0.1 to 3.0, 0.2 to 2.0, 0.3 to 2.8, 0.4 to 2.7, 0.5 to 2.6, 0.6 to 2.5, 0.7 to 2.4, 0.8 to 2.3, 0.9 to 2.2, 1.0 to 2.1, 1.1 to 2.0, 1.2 to 1.9, 1.3 to 1.8, 1.4 to 1.7, or 1.5 to 1.6, weight percent of a plasticizer. In additional non-limiting embodiments, all values and ranges of values, both whole and fractional, within one or more of the aforementioned ranges, are hereby expressly contemplated.

The plasticizer is not particularly limited and may be various aromatic and aliphatic alcohols such as sorbitol and xylitol. Also various glycols can be used such as di, tri, and tetra ethylene glycol. Also, plasticizers such as o-p-Toluene sulfonamide(O/PTSA), N-Cyclohexyl-p-toluenesulfon-amide(CTSA) or N-Ethyl-O/P-Toluene Sulfonamide (O/PETSA) could be used. In one embodiment, the plasticizer is selected from the group of caprolactam, butylbenzenesulfonamide, and combinations thereof. In another embodiment the plasticizer is caprolactam. The plasticizer and the monomer may be the same or may be different. Alternatively, the plasticizer may include a mixture of the monomer and another compound.

(E) Transferring the Second Intermediate from the Extractor into a Dryer:

The method also includes the step of (E) transferring the second intermediate from the extractor into a dryer, for example, through exit line (32) and intro entrance line (36), as set forth in FIG. 1. This step is undertaken after the step of introducing water into the reactor and after the second intermediate is formed. The dryer is not particularly limited and may be any in the art. For example, the dryer may be as generally shown in FIG. 1 as dryer (24). In other embodiments, the dryer has a top (40) and a bottom (42), as set forth in FIG. 1.

The step of transferring the second intermediate may occur utilizing any method known in the art. The second intermediate may include water and be in the form of a slurry when transferred to the dryer.

### (F) Applying Air to the Second Intermediate in the Dryer to Form the Polyamide:

The method also includes the step of applying air to the second intermediate in the dryer wherein the air is at a temperature of less than 125° C. to form the polyamide having the extractable fraction of oligomer of from 2 to 10 percent as determined by ISO 6427. In various embodiments, the air is applied at a temperature of less than 120, 115, 110, 105, 100, 95, 90, 85, 80, 75, 70, 65, or 60, ° C. In other embodiments, the air is applied at a temperature from 60 to 120, 65 to 115, 70 to 110, 75 to 105, 80 to 100, 85 to 95, or 85 to 90, ° C. In still other embodiments, the air is applied at a temperature of from 115 to 125, from 116 to 124, from 117 to 123, from 118 to 122, from 119 to 121, from 100 to 125, from 105 to 120, or from 110 to 115, ° C. In additional non-limiting embodiments, all values and ranges of values, both whole and fractional, within one or more of the aforementioned ranges, are hereby expressly contemplated.

The air may be atmospheric air but is typically an inert gas or includes 50, 55, 60, 65, 70, 75, 80, 85, 90, 95, or greater, percent of nitrogen, a noble gas, and/or another inert gas. The air may be applied to the second intermediate using any pressure or flow.

The air may be flowed into the dryer using any apparatus or method known in the art. The second intermediate may flow downwards (F3) through the dryer (24), as set forth in FIG. 1.

In various embodiments, the step of applying air includes a first step wherein the air is applied at a temperature of from 100 to 125, from 105 to 120, or from 110 to 115, ° C. and a second step wherein the air is applied at a temperature of less than 100, 95, 90, 85, 80, 75, 70, 65, 60, 55, 50, 45, 40, 35, 30, or 25, ° C. In other embodiments, the air is applied in the second step at a temperature from 60 to 120, 65 to 115, 70 to 110, 70 to 100, 75 to 105, 80 to 100, 85 to 95, or 85 to 90, ° C. In still other embodiments, the air is applied at a temperature of from 115 to 125, from 116 to 124, from 117 to 123, from 118 to 122, from 119 to 121, from 100 to 125, from 105 to 120, or from 110 to 115, ° C. In additional non-limiting embodiments, all values and ranges of values, both whole and fractional, within one or more of the aforementioned ranges, are hereby expressly contemplated. The first step may occur in the top (40) of the dryer (24) while the second step may occur in the bottom (42) of the dryer (24).

The method also typically includes the step of removing the polyamide from the dryer, for example, through removal line (38). The polyamide may be removed from the dryer and further processed, either on-line or off-line. In one embodiment, the polyamide is further processed via addition of the aforementioned lubricant to the polyamide.

### Additional Embodiments:

The method may also include the step of removing water from the extractor, for example, through removal line (34), as set forth in FIG. 1. In various embodiments, the water that is removed includes 7 to 9 or 7 to 8, weight percent of the plasticizer, the monomer, and/or a combination of both the plasticizer and the monomer. The water that is removed is typically removed at a temperature of less than 100, 95, 90, 85, 80, 75, 70, 65, 60, 55, 50, 45, 40, 35, 30, or 25, ° C.

In one embodiment, the method includes the step of removing water from the extractor subsequent to formation of the second intermediate wherein the water that is removed includes 7 to 9 weight percent of a combination of the monomer and the plasticizer. In another embodiment, the method includes the step of removing water from the extractor subsequent to formation of the second intermediate, wherein the monomer and the plasticizer are the same, and wherein the water that is removed includes 7 to 9 weight percent of a combination of the monomer and the plasticizer.

This disclosure also provides a method for producing nylon 6 having an extractable fraction of oligomer of from 2 to 6 percent as determined by ISO 6427. The method includes the steps of (A) introducing caprolactam into a top of a VK tube reactor; (B) polymerizing the caprolactam in the reactor to form a first intermediate having an extractable fraction of oligomer of about 12 percent as determined by ISO 6427; (C) transferring the first intermediate from the reactor into an extractor; (D) introducing water into the extractor (and combining the water and the first intermediate) to form a second intermediate having an extractable fraction of oligomer of from 7 to 11 percent, as determined by ISO 6427, wherein the water is introduced at a temperature of less than 100° C., and wherein the water includes 0.1 to 3.0 weight percent of caprolactam upon introduction into the extractor; (E) transferring the second intermediate from the extractor into a dryer; and (F) applying inert gas to the second intermediate in the dryer at a temperature of from 70° C. to 125° C. to form the nylon 6 having the extractable fraction of oligomer of from 2 to 6 percent as determined by ISO 6427, wherein the oligomer is a compound of 2 to 20 units of the caprolactam. Any one or more of these steps may be as described above. Moreover, the terminology “about” typically describes that the value may fluctuate by, for example, ±1, 2, 3, 4, or 5, %.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

1. A method for producing a polyamide having an extractable fraction of oligomer of from 2 to 10 percent as determined by ISO 6427, said method comprising the steps of:
A. introducing a monomer into a reactor;
B. polymerizing the monomer in the reactor to form a first intermediate having an extractable fraction of oligomer of greater than 10 percent as determined by ISO 6427;
C. transferring the first intermediate from the reactor into an extractor;
D. introducing water into the extractor to form a second intermediate having an extractable fraction of oligomer that is less than the extractable fraction of oligomer of the first intermediate, as determined by ISO 6427, wherein the water is introduced at a temperature of less than 100° C., and wherein the water comprises 0.1 to 3.0 weight percent of a plasticizer upon introduction into the extractor;
E. transferring the second intermediate from the extractor into a dryer; and
F. applying air to the second intermediate in the dryer wherein the air is at a temperature of less than 125° C. to form the polyamide having the extractable fraction of oligomer of from 2 to 10 percent as determined by ISO 6427,
wherein the oligomer is a compound of 2 to 20 repeat units of the monomer.

2. The method of claim 1 wherein the polyamide is nylon 6 that has an extractable fraction of oligomer of from 2 to 8 percent as determined by ISO 6427.

3. The method of claim 1 wherein the polyamide is nylon 6 that has an extractable fraction of oligomer of from 4 to 6 percent as determined by ISO 6427.

4. The method of claim 1 wherein the polyamide is nylon 6 that has an extractable fraction of oligomer of from 3 to 5 percent as determined by ISO 6427.

5. The method of claim 1 further comprising the step of removing water from the extractor subsequent to formation of the second intermediate wherein the water that is removed comprises 7 to 9 weight percent of a combination of the monomer and the plasticizer.

6. The method of claim 1 further comprising the step of removing water from the extractor subsequent to formation of the second intermediate, wherein the monomer and the plasticizer are the same, and wherein the water that is removed comprises 7 to 9 weight percent of a combination of the monomer and the plasticizer.

7. The method of claim 1 wherein the plasticizer is selected from the group of caprolactam, butylbenzenesulfonamide, and combinations thereof.

8. The method of claim 1 wherein the plasticizer is caprolactam.

9. The method of claim 1 wherein said step of applying air comprises:
a first step wherein the air is applied at a temperature of from 100° C. to 125° C.; and
a second step wherein the air is applied at a temperature of less than 100° C.

10. The method of claim 1 further comprising the step of adding a lubricant to the polyamide.

11. The method of claim 10 wherein the lubricant is chosen from salts of fatty acids, silicones, and mixtures thereof.

12. A method for producing nylon 6 having an extractable fraction of oligomer of from 2 to 6 percent as determined by ISO 6427, said method comprising the steps of:
A. introducing caprolactam into a top of a VK tube reactor;
B. polymerizing the caprolactam in the VK tube reactor to form a first intermediate having an extractable fraction of oligomer of about 12 percent as determined by ISO 6427;
C. transferring the first intermediate from the reactor into an extractor;
D. introducing water into the extractor to form a second intermediate having an extractable fraction of oligomer of from 7 to 11 percent, as determined by ISO 6427, wherein the water is introduced at a temperature of less than 100° C., and wherein the water comprises 0.1 to 3.0 weight percent of caprolactam upon introduction into the extractor;
E. transferring the second intermediate from the extractor into a dryer; and
F. applying inert gas to the second intermediate in the dryer wherein the inert gas is at a temperature of from 70° C. to 125° C. to form the nylon 6 having the extractable fraction of oligomer of from 2 to 6 percent as determined by ISO 6427,
wherein the oligomer is a compound of 2 to 20 units of the caprolactam.

13. The method of claim 12 wherein the nylon 6 has an extractable fraction of oligomer of from 4 to 6 percent as determined by ISO 6427.

14. The method of claim 12 wherein the nylon 6 has an extractable fraction of oligomer of from 3 to 5 percent as determined by ISO 6427.

15. The method of claim 12 further comprising the step of removing water from the extractor subsequent to formation of the second intermediate wherein the water that is removed comprises 7 to 9 weight percent of the caprolactam.

16. The method of claim 12 wherein said step of applying the inert gas comprises:
a first step wherein the inert gas is applied at a temperature of from 100° C. to 125° C.; and
a second step wherein the inert gas is applied at a temperature of from 70° C. to 100° C.

17. The method of claim 12 further comprising the step of adding a lubricant to the polyamide.

18. The method of claim 17 wherein the lubricant is chosen from salts of fatty acids, silicones, and mixtures thereof.
